(19) United States
(12) Patent Application Publication
(10) Pub. No.: US 2006/0168297 A1
(43) Pub. Date: Jul. 27, 2006

(54) Real-time multimedia transcoding apparatus and method using personal characteristic information

(75) Inventors: Tae-Gyu Kang, Daejon (KR); Do-Young Kim, Daejon (KR); Young-Sun Kim, Daejon (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Electronics and Telecommunications Research Institute

(21) Appl. No.: 11/297,236

(22) Filed: Dec. 7, 2005

(30) Foreign Application Priority Data
Dec. 8, 2004 (KR) 10-2004-0103211
Oct. 20, 2005 (KR) 10-2005-0099102

(51) Int. Cl. G06F 15/16

(52) U.S. Cl. 709/231

(57) ABSTRACT

Provided is a real-time multimedia transcoding apparatus and method using personal characteristic information. The apparatus provides a real-time multimedia transcoding apparatus using personal characteristic information for providing a fresh communication service by transforming a media type and/or a media codec by reflecting personal characteristic information such as gender and emotional condition between terminals calling through different media types and media codecs in a real-time multimedia service. The apparatus includes a receiving block for receiving a media stream; a characteristic extracting block for extracting user characteristics from the received media stream; a transforming block for transcoding the received media stream; and a transmitting block for transmitting the transcoded media stream.

### FIELD OF THE INVENTION

The present invention relates to a real-time multimedia transcoding technology; and, more particularly, to a real-time multimedia transcoding apparatus and method that can provide a multimedia service by transforming a media type or a media codec by reflecting personal characteristic information when a transmitting part and a receiving part use different media types or different media codecs to provide a real-time multimedia service by performing a linkage function between a packet network and a conventional wired/wireless network.

### DESCRIPTION OF RELATED ART

Transcoding is a technology for transforming a certain type of media into another type of media. In other words, it is a technology for transforming image/voice/text data of a predetermined bit rate or size into image/voice/text data of another bit rate or size.

For example, when an A user desires a voice call and a B user desires a text call in a voice over Internet phone (VoIP) service through a linkage between a packet network and conventional wired/wireless network, the transcoding technology is applied to a call between the A user and the B user. Also, the transcoding technology is applied to a case that an A user terminal uses an Adaptive Multi-Rate (AMR) voice codec and a B user terminal uses a Selectable Mode Vocoder (SMV) voice codec. The transcoding technology is also applied to a case that the A user terminal codes an image signal by using a Joint Photographic Experts Group (JPEG) coding technique and the B user terminal codes the image signal by using a wavelet coding technique.

The transcoding technology is necessarily required for communication between networks, to which two different standards are applied, and used in a gateway for connecting a packet network and a conventional wired/wireless network with each other. The gateway includes an access gateway, a trunk gateway and a media gateway.

The access gateway is a device required for connecting a general phone user of the wired/wireless network including a Public Switched Telephone Network (PSTN) to a packet network including the VoIP and Voice over Asynchronous Transfer mode (VoATM), and a transforming device for transmitting voice data from a general phone to the packet network.

The trunk gateway is a device for connecting the PSTN with the packet network and transmitting a lot of data generated in a public phone network to the packet network.

The media gateway is a data transforming device for transmitting data between heterogeneous networks having different standards from each other and includes the access gateway and the trunk gateway.

A standard related to the transcoding technology applied to the gateway is disclosed in Transcoding Services Invocation in the Session Initiation Protocol of Internet Engineering Task Force (IETF).

Meanwhile, a signal protocol transformation technology for a call setup is applied to the gateway to mutually transform a media type or a media codec, when different media types or the media codecs are used between the heterogeneous networks. The signal protocol transformation technology is disclosed in Request for Comments (RFC) 3261 Session Initiation Protocol (SIP), RFC 3264 Offer/Answer Service Discovery Protocol (SDP), RFC 2833 real-time transport protocol (RTP) Payload for Dynamic Tunnel Management Protocol (DTMP) Digits, Telephony Tones and Telephony Signals, RFC 2327 SDP, RFC 3108 asynchronous transfer mode (ATM) SDP, RFC 1890 RTP Profile Payload type of the IETF.

However, although diverse real-time multimedia services are provided by applying the transcoding and signal protocol transformation technology, a service that can be provided between a transmitting part capable of a voice call and a receiving part having a hearing impairments, is limited to simply transform real voice into a dry text and transform a text into a mechanical voice.

Therefore, when a real-time multimedia service is provided by transforming the voice into the text and the text into the voice, a method capable of providing a service of a high quality by reflecting diverse characteristics of a caller instead of providing a feeling of a mechanical call is required.

### SUMMARY OF THE INVENTION

It is, therefore, an object of the present invention to provide a real-time multimedia transcoding apparatus that can provide a realistic communication service by reflecting personal characteristic information and transforming a media type and a media codec such as a gender and emotional condition between terminals employing different media types and/or different media codecs in a real-time multimedia service, and a method thereof.

Other objects and advantages of the invention will be understood by the following description and become more apparent from the embodiments in accordance with the present invention, which are set forth hereinafter. It will be also apparent that objects and advantages of the invention can be embodied easily by the means defined in claims and combinations thereof.

In accordance with an aspect of the present invention, there is provided a transcoding apparatus for transforming a media stream by reflecting user characteristic information to provide a multimedia service, including: a receiving block for receiving a media stream; a characteristic extracting block for extracting user characteristics from the received media stream; a transforming block for transcoding the received media stream by reflecting user characteristic information based on the user characteristics; and a transmitting block for transmitting the transcoded media stream.

In accordance with another aspect of the present invention, there is provided a transcoding method for transforming a media stream by reflecting user characteristics information to provide a multimedia service, including the steps of: a) receiving the media stream; b) analyzing the received media stream and extracting user characteristics; and c) transcoding the received media stream by reflecting the characteristic information based on the extracted characteristic of the user.

### BRIEF DESCRIPTION OF THE DRAWINGS

The above and other objects and features of the present invention will become apparent from the following description of the preferred embodiments given in conjunction with the accompanying drawings, in which:

FIG. 1 is a block diagram showing a transcoding apparatus in accordance with an embodiment of the present invention;

FIG. 2 is a diagram showing a system of a characteristic database of FIG. 1;

FIG. 3 is a block diagram showing a network, to which the present invention is applied;

FIG. 4 is a flowchart illustrating a transcoding method using personal characteristic information in accordance with an embodiment of the present invention; and

FIG. 5 is a flowchart describing a transcoding method using personal characteristic information in accordance with another embodiment of the present invention.

### DETAILED DESCRIPTION OF THE INVENTION

Other objects and advantages of the present invention will become apparent from the following description of the embodiments with reference to the accompanying drawings. Therefore, those skilled in the art that the present invention is included can embody the technological concept and scope of the invention easily. In addition, if it is considered that detailed description on the prior art may blur the points of the present invention, the detailed description will not be provided herein. The preferred embodiments of the present invention will be described in detail hereinafter with reference to the attached drawings.

Following description exemplifies only the principles of the present invention. Even if they are not described or illustrated clearly in the present specification, one of ordinary skill in the art can embody the principles of the present invention and invent various apparatuses within the concept and scope of the present invention. The use of the conditional terms and embodiments presented in the present specification are intended only to make the concept of the present invention understood, and they are not limited to the embodiments and conditions mentioned in the specification.

In addition, all the detailed description on the principles, viewpoints and embodiments and particular embodiments of the present invention should be understood to include structural and functional equivalents to them. The equivalents include not only currently known equivalents but also those to be developed in future, that is, all devices invented to perform the same function, regardless of their structures. Hereafter, preferred embodiments of the present invention will be described in detail with reference to the drawings.

A case that a transmitting part and a receiving part use different media types will be described as an example in following embodiments. Herein, since a call response process from the receiving part to the transmitting part is operated by the same process as a call from the transmitting part to the receiving part, only the call from the transmitting part to the receiving part will be considered.

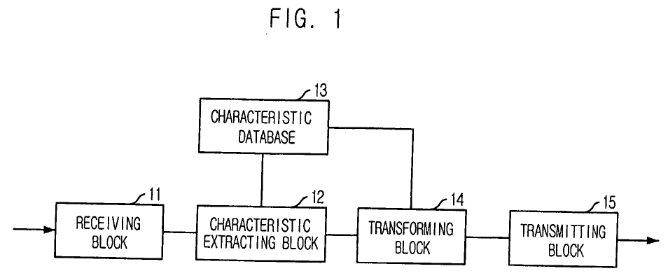

FIG. 1 is a block diagram showing a transcoding apparatus in accordance with an embodiment of the present invention.

As shown in FIG. 1, the transcoding apparatus of the present invention includes a receiving block 11, a characteristic extracting block 12, characteristic database 13, a transforming block 14 and a transmitting block 15.

For example, the receiving block 11 operates a call setup process for receiving text and voice data. That is, call setup data including codec-related information that can be used in the transmitting part are transmitted from the transmitting part, and call response data including codec-related information that can be used in the receiving part are transmitted from the receiving part. It is possible to receive call setup data and call response data by diverse protocols including Session Initial Protocol (SIP) and a H.323 protocol. For example, when M=text 79230 real-time transport protocol (RTP)/AVP 96, a 96^{th} text codec among text codecs is used and when M=audio 30000 RTP/AVP 0, a 0^{th} voice codec among voice codecs is used.

Meanwhile, the receiving block 11 receives media data from the transmitting part after the call setup. That is, the receiving block 11 receives a media packet transmitted from the transmitting part by RTP/use datagram protocol (UDP)/Internet Protocol (IP) including a packet interpreter and restores media data.

The characteristic extracting block 12 analyzes the received media data by using the characteristic database 13 and extracts characteristic information of a transmitter. When the transmitter includes its own present condition information through a terminal, the characteristic information of the transmitter is extracted by extracting the included present information. On the contrary, when the transmitter does not include its own present condition information, the characteristic information of the transmitter is extracted based on profile information of the transmitter such as a phone number and information analyzing a word, a sentence and a style included in the media data. Herein, the present condition and the characteristic information of the transmitter may include whether the transmitter is a male or a female, and diverse emotion conditions such as excitement, calmness, depression and happiness.

The transforming block 14 transforms the received media into a media type which can be used by the receiving part by using the call setup result of the receiving block 11 and the extracted characteristic information of the transmitter extracted from the characteristic extracting block 12. That is, when media type transformation is operated between the transmitting part and the receiving part based on the call setup result of the receiving block 11, the characteristic database 13 is searched based on the characteristic information of the transmitter extracted from the characteristic extracting block 12 and the media type is transformed by reflecting a call style and an emotion condition of the transmitter. Herein, a wall paper and an emoticon can be transmitted in an expression of a text.

The transmitting block 15 transmits call setup data to the receiving part and call response data to the transmitting part. Also, the transmitting block 15 transmits the media transformed by reflecting the characteristic information of the transmitter in the transforming block 14 to the receiving part. That is, the transmitting block 15 packetizes the transformed media data including a packet generator and transmits the packetized media data to the receiving part by RTP/UDP/IP.

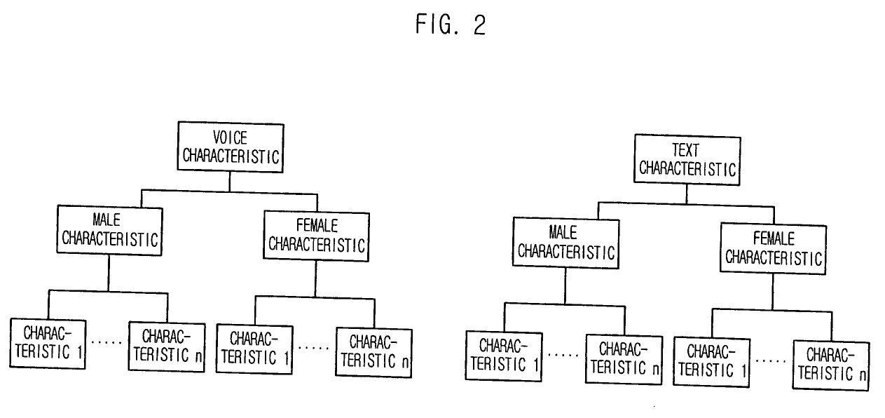

FIG. 2 is a diagram showing a system of a characteristic database of FIG. 1.

Information related to diverse wall papers, emoticons, colors of letters to be applied to a text and diverse kinds of voice information to be applied to voice are stored in the characteristic database of FIG. 1. Emotion condition based on a word, gender distinction based on a word usage, emotion condition based on a sentence code and emotion condition based on voice frequency are classifiably stored and used to extract the characteristic information of the transmitter.

As shown in FIG. 2, the system of the characteristic database of FIG. 1 is largely divided into a voice characteristic part and a text characteristic part. The voice characteristic part and the text characteristic part are, individually, divided into a male characteristic part and a female characteristic part. The male characteristic part and the female characteristic part are, individually, divided into diverse detailed characteristic parts such as a sad condition and a glad condition.

The voice characteristic part and the text characteristic part are determined by a media type transmitted from the transmitting part, and the male characteristic part and the female characteristic part are determined based on profile information such as a phone number of a user. The detailed characteristics are determined based on a voice, a word, a sentence and a style of a voice and a text. When the present condition information of the transmitter is included in the media data, the voice/text characteristics, the female/male characteristics and the detailed characteristic are determined based on the present condition information.

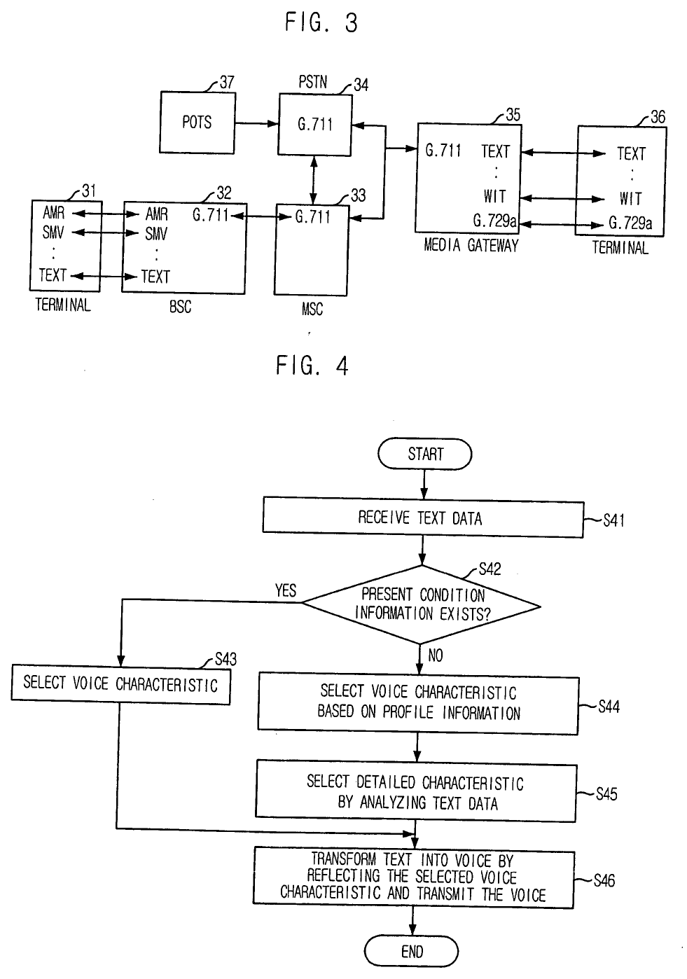

FIG. 3 is a block diagram showing a network, to which the present invention is applied.

As shown in FIG. 3, the network, to which the present invention is applied, is connected to and in which a conventional Public Switched Telephone Network (PSTN), a mobile communication network and a VoIP Internet network, and it can include a mobile Base Station Controller (BSC) 32, a Mobile Switching Center (MSC) 33, a PSTN switch 34, and a media gateway 35.

The transcoding apparatus of the present invention can be set up in the base station controller 32 and the media gateway 35 and be realized as a third server. The base station controller 32 and the media gateway 35 include the transcoding apparatus of the present invention in the embodiment. However, it is apparent that the present invention is not limited to the embodiment.

Since voice codecs, which are applied to the terminal, are different from each other based on a producer, the base station controllers 32 use diverse voice codecs. An asynchronous mobile communication network uses an Adaptive Multi-Rate (AMR) voice codec and a synchronous mobile communication network uses Selectable Mode Vocoder (SMV) as well as a G.711 voice codec and a codec for transmitting/receiving a text.

The transcoding apparatus of the present invention embedded in the base station controller 32 transforms voice data, which are coded into AMR and SMV in the terminal 31 and transmitted, into voice data coded based on G.711 and transforms text data transmitted from the text terminal 31 into the voice data, which are coded according to G.711, by reflecting personal characteristic information. Also, the transcoding apparatus transforms the voice data, which are coded based on the G.711 and transmitted from the PSTN switch 34 and the mobile communication switch 33, into the text data based on the terminal 36, or into the voice data, which are coded based on AMR and SMV.

The media gateway 35 uses Wideband codec for Internet Telephony (WIT), a G.729a voice codec and a text codec based on a codec applied to the terminal 36 for an Internet phone, such as, an IP phone, a Personal Digital Assistant (PDA) and a personal computer and uses the G.711 voice codec to communicate with the PSTN switch 34 and the mobile communication switch 33.

The transcoding apparatus of the present invention embedded in the media gateway 35 transforms voice data, which are coded based on WIT and G.729a in the terminal 36 and transmitted, into voice data coded based on G.711, and transforms text data, which are transmitted from the text terminal 36, into voice data coded based on G.711 by reflecting personal characteristic information. Also, the transcoding apparatus transforms voice data, which are transmitted from the PSTN switch 34 and the mobile communication switch 33 after coded based on G.711, into text data based on the reception terminal 31, or into voice data coded based on WIT and G.729a.

A Plain Old Telephone Service (POTS) terminal 37 is a dummy terminal without a codec. An electric voice signal transmitted from the POTS terminal 37 is transformed into voice data coded based on G.711 in the PSTN switch 34 and transmitted to the reception terminals 31 and 36.

FIG. 4 is a flowchart illustrating a transcoding method using personal characteristic information in accordance with an embodiment of the present invention and showing a case that a transmitting part wants a text communication and a receiving part wants a voice communication.

As shown in FIG. 4, the text data are transmitted from the transmitting part at step S41 and it is determined at step S42 whether the transmitter includes its own present condition information before transmission.

When the present condition information designated by the transmitter is included, a corresponding voice characteristic part is selected in the characteristic database 13 and the received text data are transmitted after transforming into voice data by reflecting the selected voice characteristic at step S46.

Meanwhile, when the present condition information designated by the transmitter is not included, a voice characteristic of the transmitter such as a female and a male is selected based on profile information of the transmitter such as a phone number in the characteristic database 13 at step S44.

At step S45, detailed characteristics of the transmitter such as the conditions of excitement, depression and happiness are selected in the characteristic database 13 by analyzing a word, a sentence and a literary style of the received text data.

At step S46, the received text data are transformed into voice data by reflecting the selected voice characteristic and the voice data are transmitted.

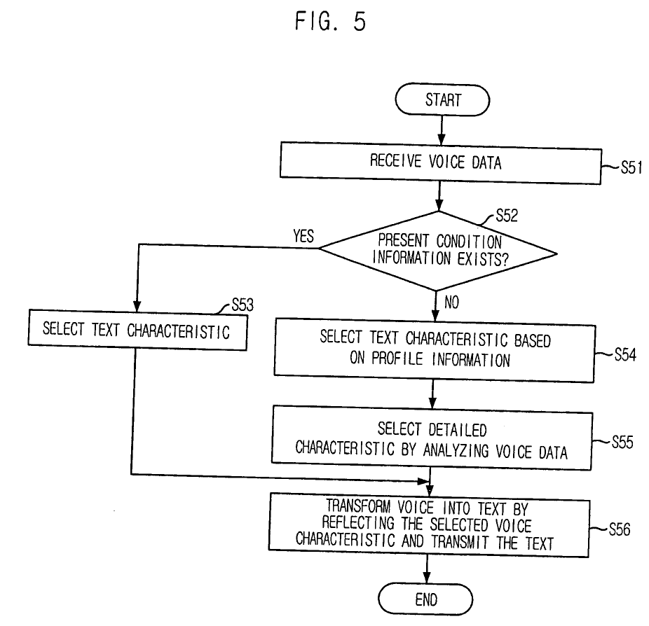

FIG. 5 is a flowchart describing a transcoding method using personal characteristic information in accordance with another embodiment of the present invention and shows a case that a transmitting part wants a voice communication and a receiving part wants a text communication.

As shown in FIG. 5, the voice data are transmitted from the transmitting part at step S51 and it is determined at step S52 whether the transmitter includes its own present condition information before transmission.

When the present condition information designated by the transmitter is included, a corresponding text characteristic is selected in the characteristic database 13 at step S53 and the received voice data are transformed into text data by reflecting the selected text characteristic and the text data are transmitted at step S56.

Meanwhile, when the present condition information designated by the transmitter is not included, a voice characteristic of the transmitter such as whether the transmitter is a female and a male is selected based on profile information of the transmitter such as a phone number in the characteristic database 13 at step S54.

At step S55, detailed characteristics of the transmitter such as the conditions of excitement, depression and happiness are selected in the characteristic database 13 by analyzing a word, a sentence and a literary style of the received voice data.

At step S56, the received voice data are transformed into text data by reflecting the selected text characteristic and the text data are transmitted.

The technology of the present invention can provide diverse call connection effects instead of a mechanical call connection in a real-time Internet multimedia service by transforming the media type and media codec of one part into those of the other part when the media type and media codecs are different between the call transmitting part and the call receiving part, and reflecting the personal characteristic information.

As described in detail, the present invention can be embodied as a program and stored in a computer-readable recording medium, such as CD-ROM, RAM, ROM, a floppy disk, a hard disk and a magneto-optical disk. Since the process can be easily implemented by those skilled in the art, further description will not be provided herein.

The present application contains subject matter related to Korean patent application Nos. 2004-0103211 and 2005-0099102, filed with the Korean Intellectual Property Office on Dec. 8, 2004, and Oct. 20, 2005, respectively, the entire contents of which are incorporated herein by reference.

While the present invention has been described with respect to certain preferred embodiments, it will be apparent to those skilled in the art that various changes and modifications may be made without departing from the scope of the invention as defined in the following claims.

What is claimed is:

1. A transcoding apparatus for transforming a media stream by reflecting user characteristic information to provide a multimedia service, comprising:
a receiving means for receiving a media stream;
a characteristic extracting means for extracting user characteristics from the received media stream;
a transforming means for transcoding the received media stream by reflecting user characteristic information based on the extracted user characteristics; and
a transmitting means for transmitting the transcoded media stream.

2. The apparatus as recited in claim 1, further comprising:
a database for storing information for extracting the user characteristics such as a sex distinction and an emotional condition, and user characteristic information to be applied to transformation of the received media stream.

3. The apparatus as recited in claim 2, wherein the characteristic extracting means extracts the user characteristics by searching the database based on user profile information, and a word or a sentence included in the received media stream.

4. The apparatus as recited in claim 2, wherein the characteristic extracting means extracts the user characteristics by searching the database based on the user profile information, and voice frequency information included in the received media stream.

5. The apparatus as recited in claim 2, wherein the characteristic extracting means extracts the user characteristics by searching the database based on present user condition information included in the received media stream.

6. The apparatus as recited in claim 3, wherein the database stores a wall paper image, an emoticon and a voice mode as user characteristic information to be applied to the transformation of the received media stream, and
the transforming means selects user characteristic information based on the user characteristics extracted from the database and transcodes the received media stream by reflecting the user characteristic information.

7. A transcoding method for transforming a media stream by reflecting user characteristic information to provide a multimedia service, comprising the steps of:
a) receiving the media stream;
b) analyzing the received media stream and extracting user characteristics; and
c) transcoding the received media stream by reflecting the user characteristic information based on the extracted user characteristics of the user.

8. The method as recited in claim 7, wherein the user characteristics are extracted by searching database based on profile information of the user, and a word and a sentence, which are included in the received media stream in the step b).

9. The method as recited in claim 7, wherein the characteristic of the user is extracted by searching database based on user profile information and voice frequency information included in the received media stream in the step b).

10. The method as recited in claim 7, wherein the user characteristics are extracted by searching database based on present user condition information included in the received media stream in the step b).

11. The method as recited in claim 8, wherein the database stores a wall paper image, an emoticon and a voice mode as user characteristic information to be applied to transformation of the received media stream, and
the user characteristic information is selected based on the user characteristics extracted from the database and the received media stream is transcoded by reflecting the characteristic information in the step c).
